(19) United States
(12) Patent Application Publication
(10) Pub. No.: US 2002/0167552 A1
(43) Pub. Date: Nov. 14, 2002

(54) Image processing method and apparatus

(75) Inventor: Jiro Senda, Kaisei-machi (JP)

Correspondence Address: MORGAN LEWIS & BOCKIUS LLP, 1111 PENNSYLVANIA AVENUE NW, WASHINGTON, DC, 20004, US

(73) Assignee: Fuji Photo Film Co., Ltd.

(21) Appl. No.: 10/140,329

(22) Filed: May 8, 2002

(30) Foreign Application Priority Data
May 11, 2001 (JP) 139820/2001

(51) Int. Cl. G09G 5/00

(52) U.S. Cl. 345/856

(57) ABSTRACT

A value of image processing parameter is set according to movement of a pointing device and image processing of an image to be displayed is carried out on the basis of the value of the image processing parameter set. To designate parameter control information which governs the kind of image processing parameter the value of which is changed in response to movement of the pointing device in a given direction and/or whether the image processing parameter is increased or decreased in response to movement of the pointing device in a given direction is made feasible. The designated parameter control information is stored, the value of the image processing parameter is set according to the stored parameter control information in response to movement of the pointing device, and image processing is carried out on the basis of the image processing parameter set.

### BACKGROUND OF THE INVENTION

1. Field of the Invention

This invention relates to an image processing method and an image processing apparatus which carry out image processing according to the movement of a pointing device.

2. Description of the Related Art

When certain kinds of phosphor are exposed to a radiation (x-rays, α-rays, β-rays, electron beams, ultraviolet rays), they store a part of energy of the radiation. Then when the phosphor which has been exposed to the radiation is exposed to stimulating rays such as visible light, light is emitted from the phosphor in proportion to the stored energy of the radiation. A phosphor exhibiting such properties is generally referred to as “a stimulable phosphor”. In this specification, the light emitted from the stimulable phosphor upon stimulation thereof will be referred to as “stimulated emission”. There has been known a radiation image recording/reproducing apparatus in which a stimulating light beam such as a laser beam is caused to scan a stimulable phosphor sheet (a sheet provided with a layer of the stimulable phosphor) which has been exposed to a radiation passing through an object such as a human body to have a radiation image of the object stored on the stimulable phosphor sheet, the stimulated emission emitted from the stimulable phosphor is photoelectrically detected, thereby obtaining a radiation image signal, and then a radiation image of the object is reproduced as a visible image on the basis of the radiation image signal on a recording medium such as a photographic film or a display such as a CRT. See, for instance, Japanese Unexamined Patent Publication No. 55(1980)-12429.

In the system, a gradation processing is carried out on the radiation image signal in order to output a visible image which is proper in density and/or contrast. The gradation processing is generally carried out on the basis of an optimal gradation correction curve (representing a gradation processing characteristic or a signal conversion characteristic) selected according to the kind of object and/or the purpose of photographing from a plurality of gradation correction curves which have been prepared for different kinds of objects and/or different purposes of photographing, or on the basis of an optimal gradation correction curve obtained by setting a reference gradation correction curve in an orthogonal coordinate system with the image signal level before conversion as one of the abscissa and the ordinate and the image signal level after conversion as the other of the abscissa and the ordinate and rotating and/or moving parallel the reference gradation correction curve about a point on the reference gradation correction curve according to the kind of object and/or the purpose of photographing.

When reading a medical image, it has been effected to change in real time the value of a parameter identifying the gradation correction curve according to movement of the pointing device and carrying out in real time a gradation processing on the basis of a gradation correction curve identified by the changed parameter on the medical image on the screen. In this case, different kinds of parameters are changed according to the direction of movement of the pointing device. That is, parameters which are changed when the pointing device is moved in a horizontal direction are different from those which are changed when the pointing device is moved in a vertical direction.

However, the kinds of parameters which are changed when the pointing device is moved in a given direction and whether the parameter is increased or decreased when the pointing device is moved in a given direction differ by makers of the image processing apparatus, and accordingly the user must use the apparatus in different ways by makers, which is troublesome. Further, there has been a problem that the kinds of parameters which are changed when the pointing device is moved in a given direction and whether the parameter is increased or decreased when the pointing device is moved in a given direction cannot be changed even in an apparatus.

### SUMMARY OF THE INVENTION

In view of the foregoing observations and description, the primary object of the present invention is to provide an image processing method and an image processing apparatus in which the kinds of parameters which are changed in response to movement of the pointing device in a given direction and/or the manner in which the parameters are increased or decreased in response to movement of the pointing device in the given direction can be changed by the user.

In accordance with a first aspect of the present invention, there is provided an image processing method of setting a value of image processing parameter according to movement of a pointing device and carrying out image processing of an image to be displayed on the basis of the value of the image processing parameter set, wherein the improvement comprising the steps of

making it feasible to designate parameter control information which governs the kind of image processing parameter the value of which is changed in response to movement of the pointing device in a given direction and/or whether the image processing parameter is increased or decreased in response to movement of the pointing device in a given direction,

storing the designated parameter control information,

setting the value of the image processing parameter according to the stored parameter control information in response to movement of the pointing device, and

carrying out image processing on the basis of the image processing parameter set.

In accordance with a second aspect of the present invention, there is provided an image processing apparatus in which a value of image processing parameter is set according to movement of a pointing device and carrying out image processing of an image to be displayed on the basis of the value of the image processing parameter set, wherein the improvement comprises

a designating means for designating parameter control information which governs the kind of image processing parameter the value of which is changed in response to movement of the pointing device in a given direction and/or whether the image processing parameter is increased or decreased in response to movement of the pointing device in a given direction,

a storage means which stores the parameter control information designated by the designating means,

a parameter setting means which sets the value of the image processing parameter in response to movement of the pointing device according to the parameter control information stored in the storage means, and

an image processing means which carries out image processing on the basis of the image processing parameter set by the parameter setting means.

The pointing device is generally moved up and down or right and left to change the image processing parameter. However, the pointing device may be moved in any direction to change the image processing parameter.

Generally when an image processing parameter is set to be increased in response to movement of the pointing device in a given direction, the image processing parameter is set to be decreased in response to movement of the pointing device in the reverse direction. For example, when a first parameter is set to be increased in response to rightward movement of the pointing device, the first image processing parameter is set to be decreased in response to leftward movement of the pointing device. When a second parameter is set to be increased in response to upward movement of the pointing device, the second image processing parameter is set to be decreased in response to downward movement of the pointing device. Only the direction in which the image processing parameter is increased or decreased may be designated or both the directions in which the image processing parameter is respectively increased and decreased may be designated.

The image processing parameter may include, for instance, a window center or a window width in a window level processing.

The window level processing will be described with reference to FIG. 2, which shows the correlation between the input value and the output value in the window level processing.

The window level processing is a kind of gradation processing, the contents of which can be controlled by changing the characteristics of the gradation correction curve by controlling two parameters, the window width and the window center.

When the window width is widened, the inclination of the gradation correction curve is decreased and accordingly, the contrast of the image is weakened. To the contrast when the window width is narrowed, the inclination of the gradation correction curve is increased and accordingly, the contrast of the image is enhanced. When the window center is shifted rightward, the output value for a given input value is reduced and, for instance, the brightness of the image is lowered. To the contrast, when the window center is shifted leftward, the output value for a given input value is increased and, for instance, the brightness of the image is increased.

The storage means may be arranged to store a plurality of pieces of the parameter control information, each governing the kind of image processing parameter the value of which is changed in response to movement of the pointing device in a given direction and/or whether the image processing parameter is increased or decreased in response to movement of the pointing device in the given direction, designated by the designating means together with pieces of discriminating information for discriminating each piece of parameter control information from the others, while the parameter setting means is arranged to set the value of the image processing parameter in response to movement of the pointing device according to the parameter control information selected by the discriminating information.

In the image processing method and the image processing apparatus in accordance with the present invention, the user can freely designate the parameter control information and as a result, the kinds of parameters which are changed in response to movement of the pointing device in a given direction and/or the manner in which the parameters are increased or decreased in response to movement of the pointing device in the given direction can be changed by the user.

When the storage means is arranged to store a plurality of pieces of the parameter control information, the storage means can store parameter control information desired by each of a plurality of users, and accordingly, one image processing apparatus can be used by a plurality of users with the kinds of parameters which are changed in response to movement of the pointing device in a given direction and/or the manner in which the parameters are increased or decreased in response to movement of the pointing device in the given direction set in a manner desired by each of the users.

### BRIEF DESCRIPTION OF THE DRAWINGS

FIG. 1 is a block diagram showing an image processing apparatus in accordance with an embodiment of the present invention,

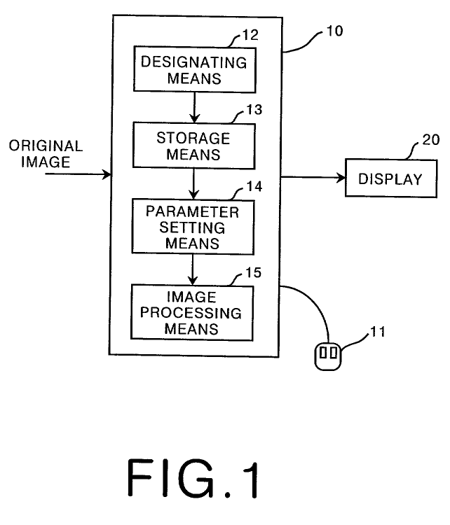

FIG. 2 is a view showing the correlation between the input value and the output value in the window level processing,

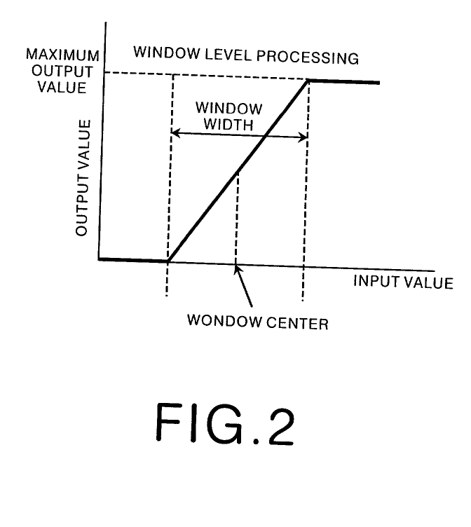

FIG. 3 is a view showing an example of parameter control information stored in the storage means, and

FIG. 4 is a view showing processing in response to movement of the pointing device.

### DESCRIPTION OF THE PREFERRED EMBODIMENT

An image processing apparatus in accordance with an embodiment of the present invention will be described, hereinbelow. In this embodiment, the image processing apparatus carries out a gradation processing by a window level processing.

The image processing apparatus 10 of this embodiment comprises a pointing device 11 for setting a value of an image processing parameter, a designating means 12 for designating parameter control information which governs the kind of image processing parameter the value of which is changed in response to movement of the pointing device in a given direction and whether the image processing parameter is increased or decreased in response to movement of the pointing device in the given direction, a storage means 13 which stores the parameter control information designated by the designating means 12, a parameter setting means 14 which sets the value of the image processing parameter in response to movement of the pointing device 11 according to the parameter control information stored in the storage means 13, and an image processing means 15 which carries out image processing on the basis of the image processing parameter set by the parameter setting means 14. A display 20 for displaying an image is connected to the image processing apparatus 10.

The pointing device 11 may be, for instance, a mouse, a track ball or a joy-stick.

The designating means 12 may be any means such as a keyboard so long as the kind of an image processing parameter which is changed in response to movement of the pointing device 11 can be designated for each of the horizontal directions and the vertical directions by the means and whether the image processing parameter is to be increased or decreased in response to movement of the pointing device can be designated in each of the horizontal directions or the vertical directions. Further, the pointing device 11 may double as the designating means 12.

In this particular embodiment, which of the window width and the window center is changed in response to movement of the pointing device 11 in the horizontal directions (left and right), which of the window width and the window center is changed in response to movement of the pointing device 11 in the vertical directions (up and down), and the directions of movement of the pointing device 11 in which the image processing parameters (the window width or the window center) are increased are designated.

The storage means 13 stores parameter control information comprising the kind of image processing parameter the value of which is changed in response to movement of the pointing device in a given direction and the direction of movement of the pointing device 11 in which the image processing parameter is increased together with pieces of discriminating information, and may be, for instance, a hard disc. The discriminating information is for discriminating each piece of parameter control information from a plurality of pieces of the parameter control information stored in the storage means 13 and may be, for instance, a file name to be simultaneously stored in the storage means 13 or information on the maker of the parameter control information to be simultaneously stored in the storage means 13.

The parameter control information to be stored in the storage means 13 will be described in more detail here. In this particular embodiment, since the pointing device 11 is moved in the horizontal directions (right and left) and in the vertical directions (up and down) to change the window width and the window center, when the kind of the parameter (the window width or the window center) to be changed in response to movement of the pointing device in one of the horizontal directions and the vertical directions is designated, the kind of the parameter to be changed in response to movement of the pointing device in the other of the horizontal directions and the vertical directions is determined. Similarly, when the direction of movement of the pointing device 11 in which the parameter is increased is designated to be one direction, the direction of movement of the pointing device 11 in which the parameter is decreased is determined to be the reverse direction. For example, if it is designated that the window width is changed in response to horizontal movement of the pointing device 11 so that the window width is increased as the pointing device 11 is moved rightward, the window center is changed in response to vertical movement of the pointing device 11 and as the pointing device 11 is moved leftward, the window width is decreased.

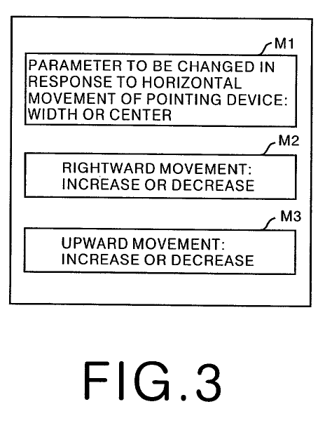

Accordingly, in this particular embodiment, which of the window width or the window center is to be changed in response to horizontal movement of the pointing device 11 is stored in storage area M1, whether the parameter is increased or decreased in response to rightward movement of the pointing device is stored in storage area M2 and whether the parameter is increased or decreased in response to upward movement of the pointing device is stored in storage area M3 as shown in FIG. 3.

Further, by setting in advance in the parameter setting means 14 directions of movement of the pointing device 11 to control values of parameters (horizontal directions and vertical directions) and kinds of image processing parameters to be controlled in response to movement of the pointing device 11 (window width and window center), the parameter setting means 14 can identify which of the window width and the window center is to be changed in response to movement of the pointing device 11 in the horizontal directions and the vertical directions and whether the parameter is to be increased or decreased in response to right and left movement of the pointing device 11 and up and down movement of the same.

In this particular embodiment, three pieces of information respectively stored in the storage areas M1 to M3 are employed as the parameter control information, and a file name is input through the designating means 12 (a keyboard or the like) and is stored in the storage means 13 together with the parameter control information. A plurality of pieces of parameter control information respectively attached with the file name are stored in the storage means 13.

Various parameters other than those described above to be changed in response to horizontal or vertical movement of the pointing device 11 and the direction in which the parameter is increased may be stored in the storage means 13 as the parameter control information.

The display 20 may be, for instance, a CRT monitor or a liquid crystal monitor.

The operation of the image processing apparatus of this embodiment will be described, hereinbelow.

The user first designates parameter control information on an interface screen (not shown) by the use of the designating means 12 and inputs a file name as the discriminating information for the parameter control information. Information which is not designated by the user is processed as a default. The storage means 13 stores the parameter control information designated by the user together with its file name.

Though the user can use default parameter control information prepared in advance without designating a parameter control information, it is assumed here that the user designates parameter control information so that the window width is changed in response to horizontal movement of the pointing device 11 so that the window width is increased as the pointing device is moved rightward and the window center is changed in response to vertical movement of the pointing device 11 so that the window center is increased (the window center is shifted rightward) as the pointing device is moved upward.

Then the user selects one file out of one or more files displayed on the interface screen (not shown) by the use of the designating means 12 or the pointing device 11.

The parameter setting means 14 reads out the parameter control information file as selected by the user from the storage means 13, and sets the kind of image processing parameter to be changed in response to horizontal movement of the pointing device 11, the kind of image processing parameter to be changed in response to vertical movement of the pointing device 11, and in which direction the pointing device 11 is to be moved to increase or decrease the corresponding image processing parameters on the basis of information stored in the storage areas M1 to M3 of the storage means 13.

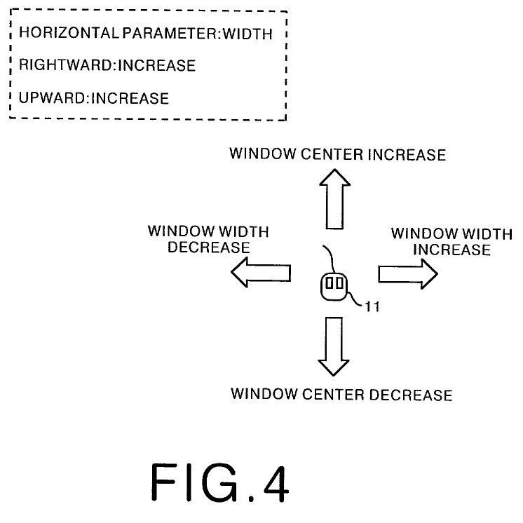

The processing executed by the parameter setting means 14 will be described with reference to FIG. 4, hereinbelow.

The parameter setting means 14 sets the window width so that the window width is increased as the pointing device 11 is moved rightward and is decreased as the pointing device 11 is moved leftward, and sets the window center so that the window center is shifted rightward as the pointing device 11 is moved upward and is shifted leftward as the pointing device 11 is moved downward.

When the pointing device 11 is moved by the user, the window width is changed and the window center is shifted in real time, thereby setting in real time the gradation correction curve, according to the direction and the amount of movement of the pointing device 11.

The image processing means 15 carries out a gradation processing on the original image on the basis of the image processing parameters, i.e., the gradation correction curve, set by the parameter setting means 14, and outputs the processed image signal to the display 20. Then the display 20 displays an image on the basis of the processed image signal.

In the image processing means of this embodiment, the user can freely designate the kinds of parameters which are changed in response to movement of the pointing device in a given direction and/or the direction in which the parameters are increased or decreased in response to movement of the pointing device and accordingly, the user can carries out the image processing by a desired action.

Though, in the embodiment described above, the window width and the window center are designated as the image processing parameters, any other image processing parameters may be designated as the image processing parameter.

Further, the amount by which the parameter is changed per unit amount of movement of the pointing device may be designated as the parameter control information in addition to the direction of movement of the pointing device which governs the kind of parameter to be changed and the direction of movement of the pointing device which governs increase/decrease of the parameter.

What is claimed is:

1. An image processing method of setting a value of image processing parameter according to movement of a pointing device and carrying out image processing of an image to be displayed on the basis of the value of the image processing parameter set, wherein the improvement comprising the steps of
making it feasible to designate parameter control information which governs the kind of image processing parameter the value of which is changed in response to movement of the pointing device in a given direction and/or whether the image processing parameter is increased or decreased in response to movement of the pointing device in a given direction,
storing the designated parameter control information,
setting the value of the image processing parameter according to the stored parameter control information in response to movement of the pointing device, and
carrying out image processing on the basis of the image processing parameter set.

2. An image processing apparatus in which a value of image processing parameter is set according to movement of a pointing device and carrying out image processing of an image to be displayed on the basis of the value of the image processing parameter set, wherein the improvement comprises
a designating means for designating parameter control information which governs the kind of image processing parameter the value of which is changed in response to movement of the pointing device in a given direction and/or whether the image processing parameter is increased or decreased in response to movement of the pointing device in a given direction,
a storage means which stores the parameter control information designated by the designating means,
a parameter setting means which sets the value of the image processing parameter in response to movement of the pointing device according to the parameter control information stored in the storage means, and
an image processing means which carries out image processing on the basis of the image processing parameter set by the parameter setting means.

3. An image processing apparatus as defined in claim 2 in which the image processing parameter designated by the designating means includes a window center and a window width in a window level processing.

4. An image processing apparatus as defined in claim 2 in which the storage means is arranged to store a plurality of pieces of the parameter control information, each governing the kind of image processing parameter the value of which is changed in response to movement of the pointing device in a given direction and/or whether the image processing parameter is increased or decreased in response to movement of the pointing device in a given direction, designated by the designating means together with pieces of discriminating information for discriminating each piece of parameter control information from the others, and the parameter setting means is arranged to set the value of the image processing parameter in response to movement of the pointing device according to the parameter control information selected by the discriminating information.
